(19) United States
(12) Patent Application Publication
(10) Pub. No.: US 2011/0191254 A1
(43) Pub. Date: Aug. 4, 2011

(54) Web User Interface

(75) Inventor: Everett L. Womack, Wichita, KS (US)

(73) Assignee: Accenture Global Services GmbH, Schaffhausen (CH)

(21) Appl. No.: 12/700,392

(22) Filed: Feb. 4, 2010

(51) Int. Cl. G06Q 10/00

(52) U.S. Cl. 705/301

(57) ABSTRACT

Methods, computer-readable media, and apparatuses process data for delegating the approval and initiation of different types of transactions to delegates by a manager. The manager provides delegate configuration information so that a delegate is able to approve or initiate a transaction request during a specified time period. The transaction request may be escalated to a next level of approval when an escalation limit has not been reached. More than one delegate may be configured, where delegate configuration information is indicative that a first delegate is associated with a first transaction type and a second delegate is associated with a second transaction type. When a transaction request does not require approval by the manager during a designated time period, the transaction request may be automatically approved to initiate the transaction request. The manager may be notified when the initiator of the transaction request is a delegate of the manager.

### FIELD

This invention relates generally to a web user interface for delegating the approval or the initiation of a transaction request.

### BACKGROUND

Human Resource (HR) transactions support employee administration, including salary information, employment status, and employee information, in which HR information is typically entered into a computer system by HR professionals, managers, and/or employees. With traditional systems, a computer system often captures data from a software application by snooping the contents of a display that is not actually intended for data transport or inspection by programs. This approach is referred as screen scraping. For example, display memory of a smart terminal may be read through its auxiliary port. Alternatively, HTML data in generated web pages may be parsed with programs designed to mine-out particular patterns of content. However, even minor changes in the data format of the data being snooped may break screen scraping regardless of the approach.

In addition to deficiencies concerning data extraction, traditional HR systems often support HR transactions in which related activities occur in a non-connected sequence of display screens. For example, a user may start a transaction in an application and then log off. A person may subsequently enter into another part of the application for approval and then notify the next person that the item is in the next person's queue for approval.

### BRIEF SUMMARY

The present invention provides methods, apparatuses, and computer-readable media for delegating the approval and initiation of different types of transactions to delegates by a manager.

With another aspect of the disclosure, a manager provides delegate configuration information so that a delegate is able to approve a transaction request during a specified time period. When the delegate configuration information is activated, the transaction request is sent to the delegate for approval before the transaction request is initiated.

With another aspect of the disclosure, another aspect of the disclosure, a manager provides delegate configuration information so that a delegate is able to initiate a transaction request during a specified time period. When the delegate configuration information is activated, the delegate is able to initiate the transaction request.

With another aspect of the disclosure, a transaction request is escalated to a next level of approval when an escalation limit has not been reached.

With another aspect of the disclosure, delegate configuration information is indicative that a first delegate is associated with a first transaction type and a second delegate is associated with a second transaction type. When a transaction request requires approval by the manager and the delegate configuration information is activated, the transaction request is sent to the first delegate for the first transaction type and to the second delegate for the second transaction type for approval before the transaction is initiated.

With another aspect of the disclosure, delegates may be changed for a transaction type based on the activation information and the delegate function information. A plurality of delegates may also be associated with the transaction type.

With another aspect of the disclosure, when a transaction request does not require approval by the manager during a designated time period, the transaction request is automatically approved in order to initiate the associated transaction.

With another aspect of the disclosure, a manager is notified when the initiator of the transaction request is a delegate for the manager.

### BRIEF DESCRIPTION OF THE DRAWINGS

The present invention is illustrated by way of example and not limited in the accompanying figures in which like reference numerals indicate similar elements and in which:

FIG. 1 shows a computer system used in supporting a web user interface in accordance with an embodiment of the invention.

FIG. 2 shows a computer configuration using in supporting a web user interface in accordance with an embodiment of the invention.

FIG. 3 shows a flow diagram for delegation configuration in accordance with an embodiment of the invention.

FIG. 4 shows a work flow for salary change in accordance with an embodiment of the invention.

FIG. 5 shows a work flow for contact information in accordance with an embodiment of the invention.

FIG. 6 shows a work flow for demotion in accordance with an embodiment of the invention.

FIG. 7 shows a work flow for direct deposit in accordance with an embodiment of the invention.

FIG. 8 shows a work flow for emergency contact information in accordance with an embodiment of the invention.

FIG. 9 shows a work flow for employment information in accordance with an embodiment of the invention.

FIG. 10 shows a work flow for hire in accordance with an embodiment of the invention.

FIG. 11 shows a work flow for completing an I9 form in accordance with an embodiment of the invention.

FIG. 12 shows a work flow for personal information in accordance with an embodiment of the invention.

FIG. 13 shows a work flow for promotion in accordance with an embodiment of the invention.

FIG. 14 shows a work flow for property in accordance with an embodiment of the invention.

FIG. 15 shows a work flow for rehire in accordance with an embodiment of the invention.

FIG. 16 shows a work flow for compensation information in accordance with an embodiment of the invention.

FIG. 17 shows a work flow for status change in accordance with an embodiment of the invention.

FIG. 18 shows a work flow for termination in accordance with an embodiment of the invention.

FIG. 19 shows a work flow for transfer in accordance with an embodiment of the invention.

FIG. 20 shows a work flow for completing a W4 form in accordance with an embodiment of the invention.

### DETAILED DESCRIPTION

According to aspects of the disclosure, a web-based user interface supports business transactions, including human resource activities and financial management, in which the web-based interface provides a unified and continuous execution flow to a user.

In a manufacturing environment, for example, allowing a manager to delegate authority for different human resource activities can enable the manager to concentrate efforts on the manufacturing floor to resolve urgent manufacturing problems.

With another aspect of the disclosure, an HR professional, manager, or employee may be involved in an HR transaction. Different types of HR transactions may be supported, including salary change, delegation configuration, entry of contact or emergency contact information, employee information, hiring, rehiring, terminating an employee, demotion or promotion of an employee, direct deposit for an employee, status change of an employee, compensation information for an employee, competition of government forms (e.g., I9 forms and W4 forms), and transferring of an employee.

With another aspect of the disclosure, a web-based interface provides an integrated and continuous experience to a user. The web-based interface offers flexible delegate functionality to accommodate a manager that needs delegates to perform selected functions. The web-based interface typically appears more intuitive to users than traditional systems.

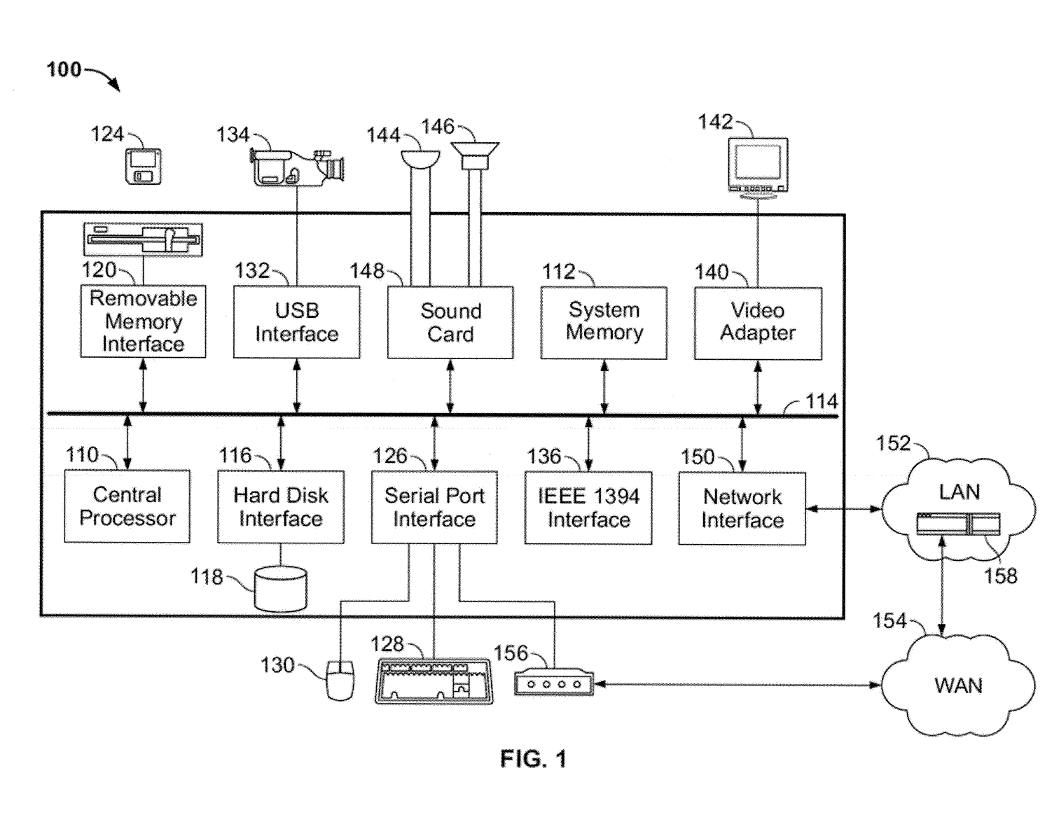

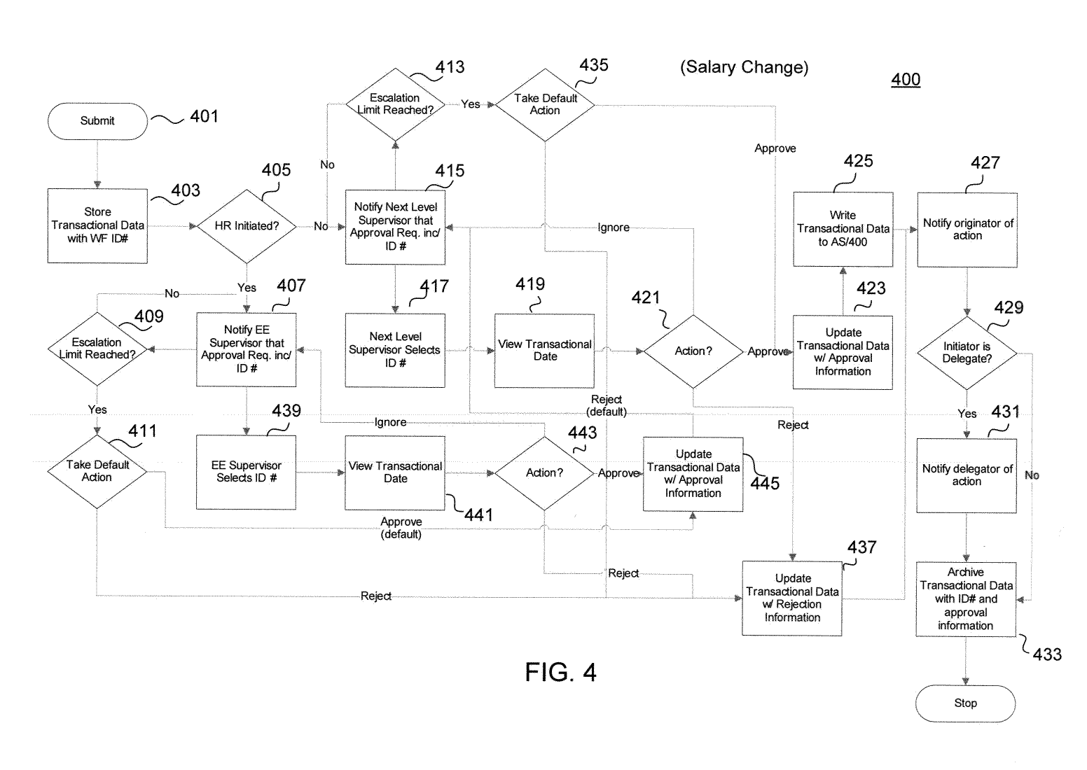

Referring to FIG. 1, elements of the present invention may be implemented with computer systems, such as the system 100. System 100 may support different types of transactions for a service, e.g., human resources as will be discussed. System 100 consequently executes processes (workflows) 400-2000 corresponding to FIGS. 4-20, respectively, in accordance with aspects for the invention as disclosed herein.

Computer 100 includes a central processor 110, a system memory 112 and a system bus 114 that couples various system components including the system memory 112 to the central processor unit 110. System bus 114 may be any of several types of bus structures including a memory bus or memory controller, a peripheral bus, and a local bus using any of a variety of bus architectures. The structure of system memory 112 is well known to those skilled in the art and may include a basic input/output system (BIOS) stored in a read only memory (ROM) and one or more program modules such as operating systems, application programs and program data stored in random access memory (RAM).

Computer 100 may also include a variety of interface units and drives for reading and writing data. In particular, computer 100 includes a hard disk interface 116 and a removable memory interface 120 respectively coupling a hard disk drive 118 and a removable memory drive 122 to system bus 114. Examples of removable memory drives include magnetic disk drives and optical disk drives. The drives and their associated computer-readable media, such as a floppy disk 124 provide nonvolatile storage of computer readable instructions, data structures, program modules and other data for computer 100. A single hard disk drive 118 and a single removable memory drive 122 are shown for illustration purposes only and with the understanding that computer 100 may include several of such drives. Furthermore, computer 100 may include drives for interfacing with other types of computer readable media.

A user can interact with computer 100 with a variety of input devices. FIG. 1 shows a serial port interface 126 coupling a keyboard 128 and a pointing device 130 to system bus 114. Pointing device 128 may be implemented with a mouse, track ball, pen device, or similar device. Of course one or more other input devices (not shown) such as a joystick, game pad, satellite dish, scanner, touch sensitive screen or the like may be connected to computer 100.

Computer 100 may include additional interfaces for connecting devices to system bus 114. FIG. 1 shows a universal serial bus (USB) interface 132 coupling a video or digital camera 134 to system bus 114. An IEEE 1394 interface 136 may be used to couple additional devices to computer 100. Furthermore, interface 136 may configured to operate with particular manufacture interfaces such as FireWire developed by Apple Computer and i.Link developed by Sony. Input devices may also be coupled to system bus 114 through a parallel port, a game port, a PCI board or any other interface used to couple and input device to a computer.

Computer 100 also includes a video adapter 140 coupling a display device 142 to system bus 114. Display device 142 may include a cathode ray tube (CRT), liquid crystal display (LCD), field emission display (FED), plasma display or any other device that produces an image that is viewable by the user. Additional output devices, such as a printing device (not shown), may be connected to computer 100.

Sound can be recorded and reproduced with a microphone 144 and a speaker 166. A sound card 148 may be used to couple microphone 144 and speaker 146 to system bus 114. One skilled in the art will appreciate that the device connections shown in FIG. 1 are for illustration purposes only and that several of the peripheral devices could be coupled to system bus 114 via alternative interfaces. For example, video camera 134 could be connected to IEEE 1394 interface 136 and pointing device 130 could be connected to USB interface 132.

Computer 100 can operate in a networked environment using logical connections to one or more remote computers or other devices, such as a server, a router, a network personal computer, a peer device or other common network node, a wireless telephone or wireless personal digital assistant. Computer 100 includes a network interface 150 that couples system bus 114 to a local area network (LAN) 152. Networking environments are commonplace in offices, enterprise-wide computer networks and home computer systems.

A wide area network (WAN) 154, such as the Internet, can also be accessed by computer 100. FIG. 1 shows a modem unit 156 connected to serial port interface 126 and to WAN 154. Modem unit 156 may be located within or external to computer 100 and may be any type of conventional modem such as a cable modem or a satellite modem. LAN 152 may also be used to connect to WAN 154. FIG. 1 shows a router 158 that may connect LAN 152 to WAN 154 in a conventional manner.

It will be appreciated that the network connections shown are exemplary and other ways of establishing a communications link between the computers can be used. The existence of any of various well-known protocols, such as TCP/IP, Frame Relay, Ethernet, FTP, HTTP and the like, is presumed, and computer 100 can be operated in a client-server configuration to permit a user to retrieve web pages from a web-based server. Furthermore, any of various conventional web browsers can be used to display and manipulate data on web pages.

The operation of computer 100 can be controlled by a variety of different program modules. Examples of program modules are routines, programs, objects, components, and data structures that perform particular tasks or implement particular abstract data types. The present invention may also be practiced with other computer system configurations, including hand-held devices, multiprocessor systems, microprocessor-based or programmable consumer electronics, network PCS, minicomputers, mainframe computers, personal digital assistants and the like. Furthermore, the invention may also be practiced in distributed computing environments where tasks are performed by remote processing devices that are linked through a communications network. In a distributed computing environment, program modules may be located in both local and remote memory storage devices.

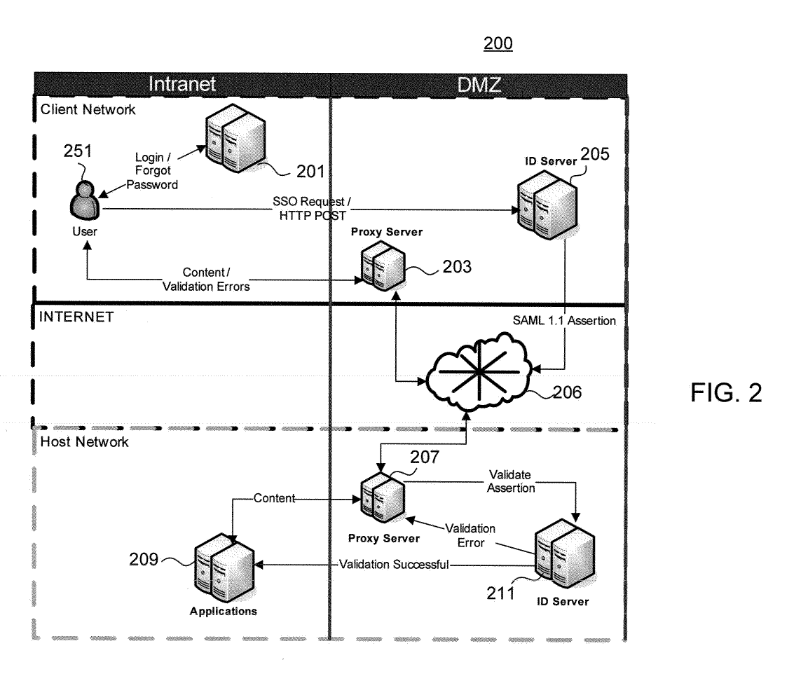

FIG. 2 shows computer configuration 200 using in supporting a web user interface in accordance with an embodiment of the invention. While FIG. 1 shows an embodiment in which a single computer is explicitly shown so that a manager can delegate approval and initiation of different transaction types, computer configuration 200 incorporates a plurality of computers for providing security, verifying authorization of the user 251, executing workflows, and displaying corresponding screens to user 251. User 251 may be a manager entering delegate configuration information or a delegate approving or initiating a transaction request.

User 251 accesses workflows that execute on computer 209 from client computer 201 through computers 203, 205, 207, and 211 (which may be collectively referred as the DMZ) and internet/intranet 206. Computer 209 also provides the content for corresponding screens that are displayed on client computer 201.

DMZ is the acronym for demilitarized zone, corresponding to a computer or small sub-network that resides between a trusted internal network, e.g., as a corporate private LAN, and an untrusted external, e.g., as the public Internet. Typically, the DMZ contains devices accessible to Internet traffic, e.g., Web (HTTP) servers, FTP servers, SMTP (e-mail) servers, and DNS servers. The term is derived from the military meaning, which is a buffer area between two enemies.

With some embodiments, a portal enables a user to select a screen that is associated with a corresponding transaction type from a set of workflows. The selected screen may include one or more sub-screens. Embodiments may support different services including human resources (benefits and payroll) and financial management.

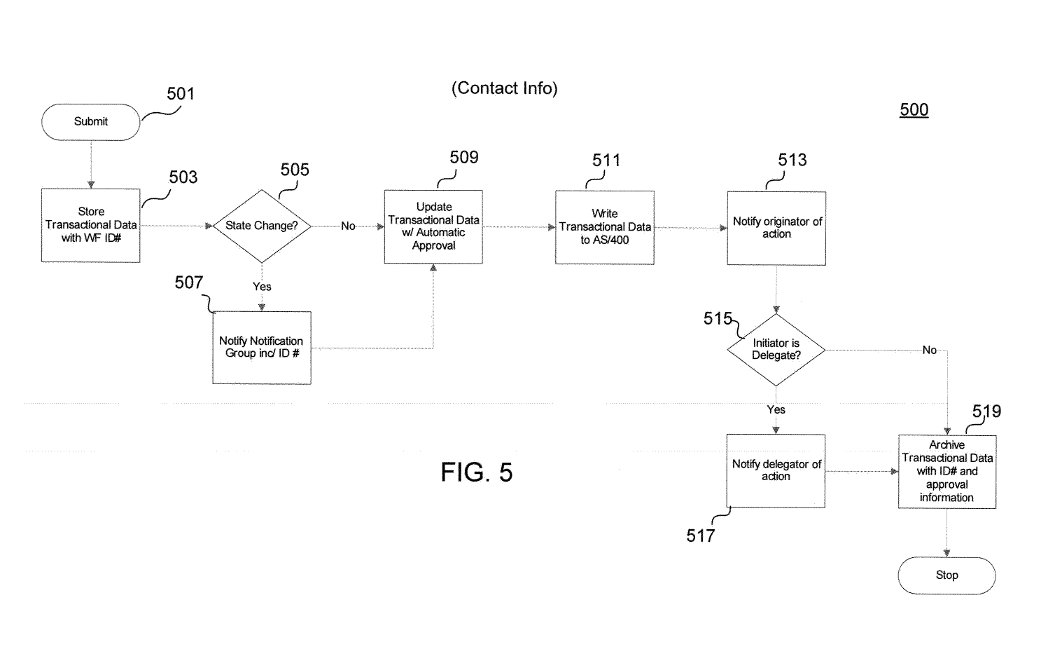

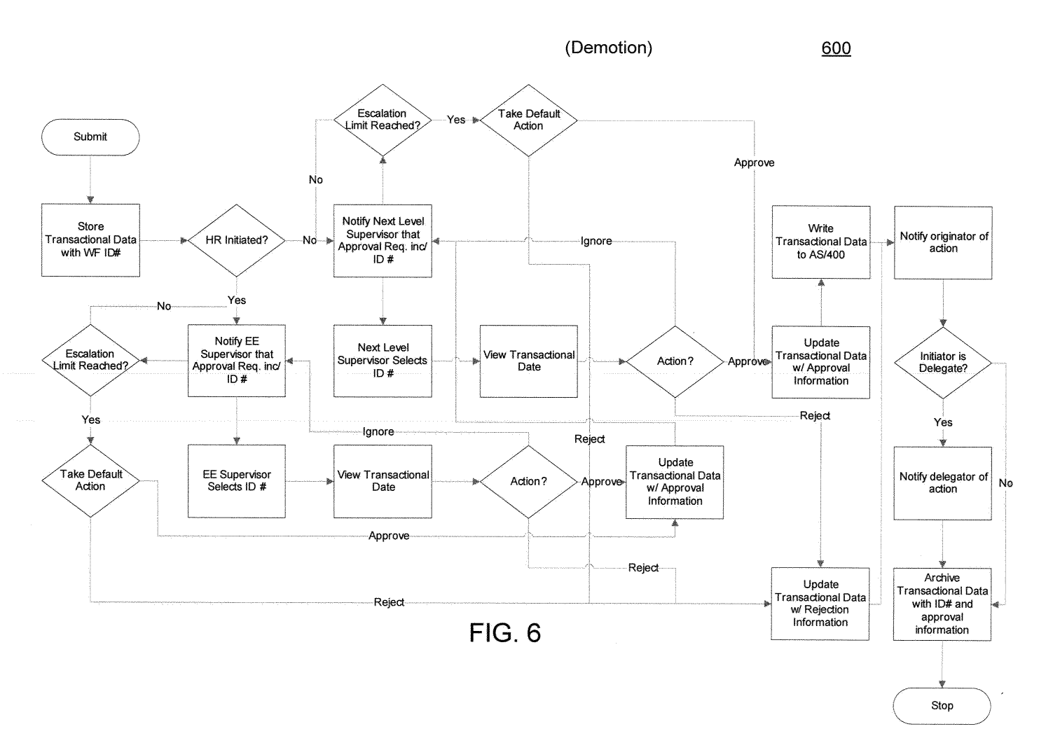

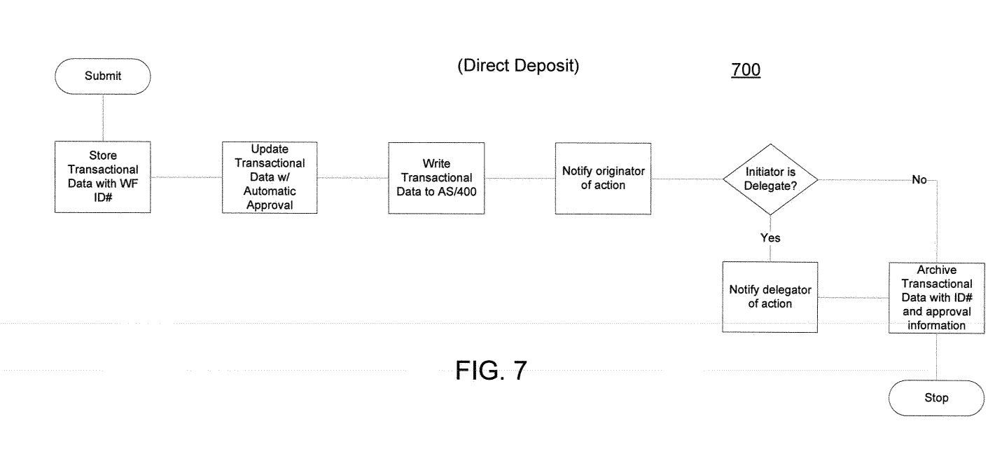

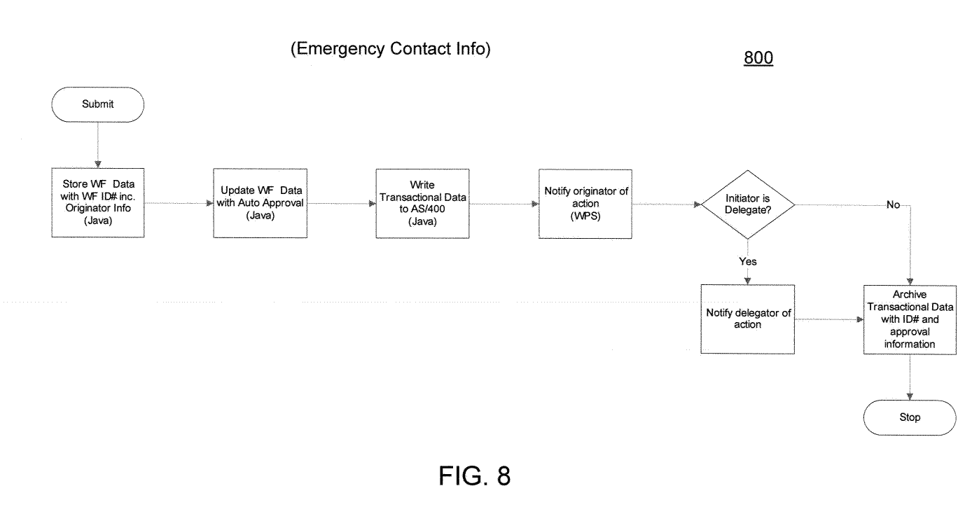

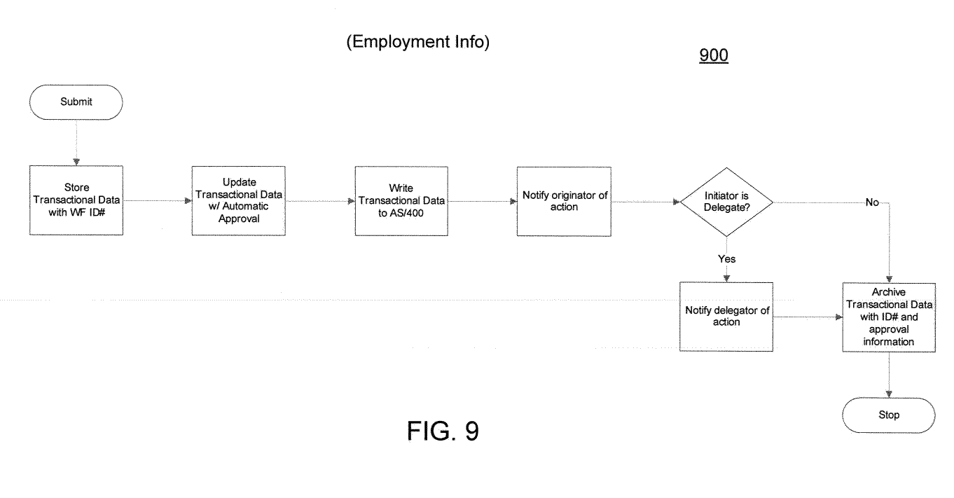

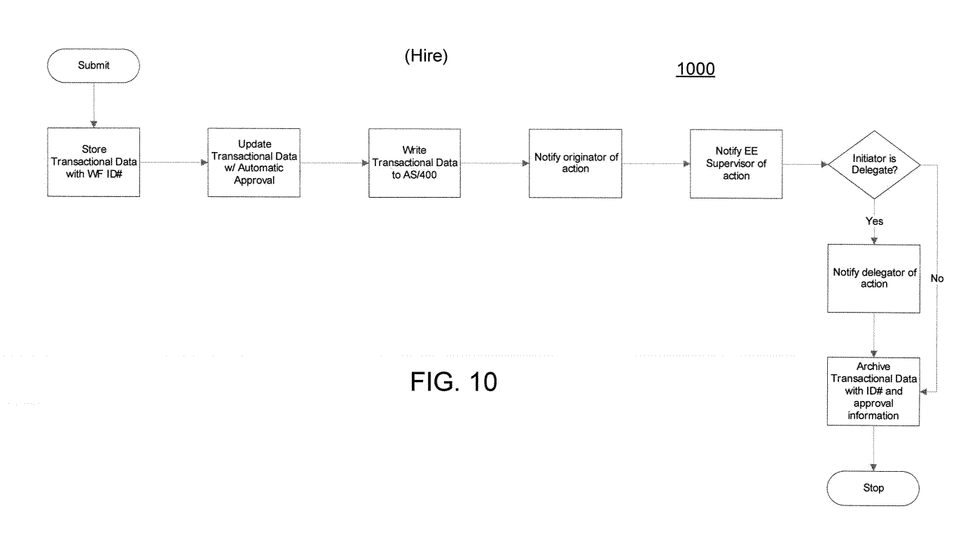

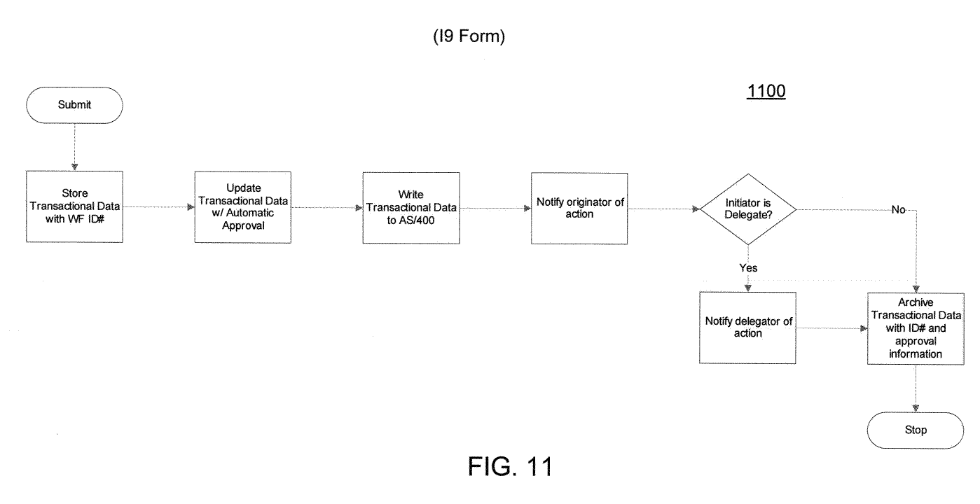

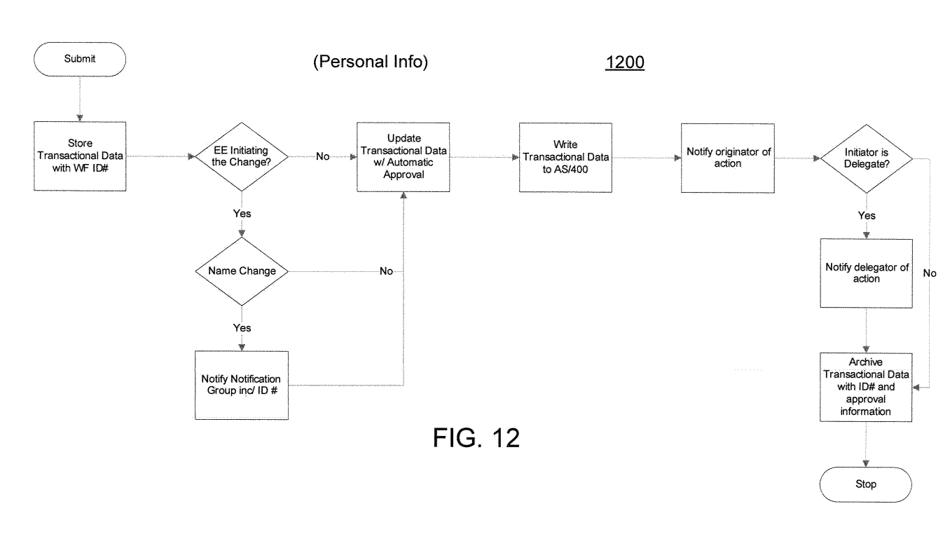

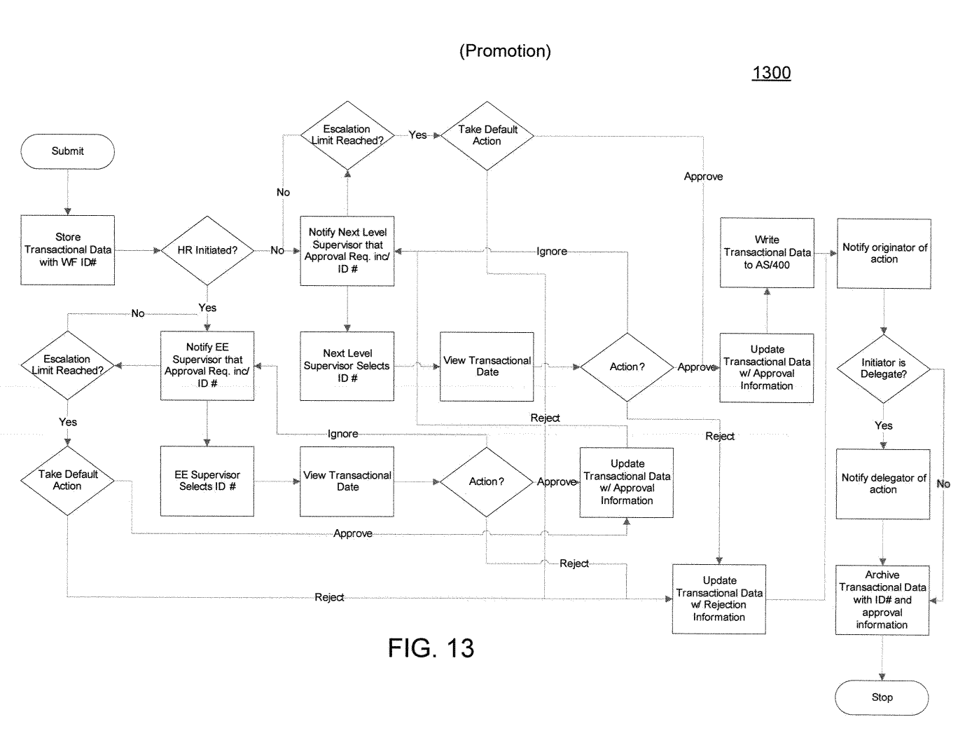

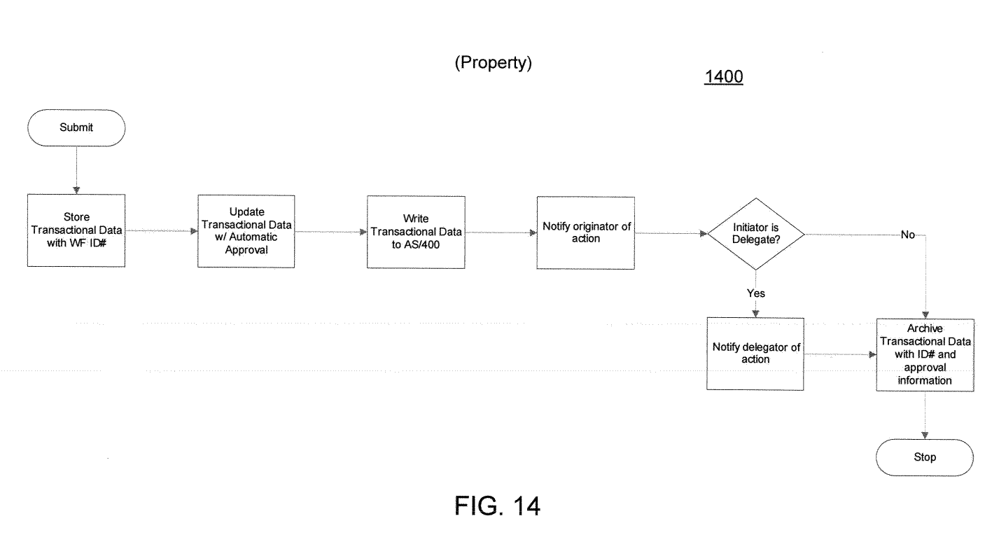

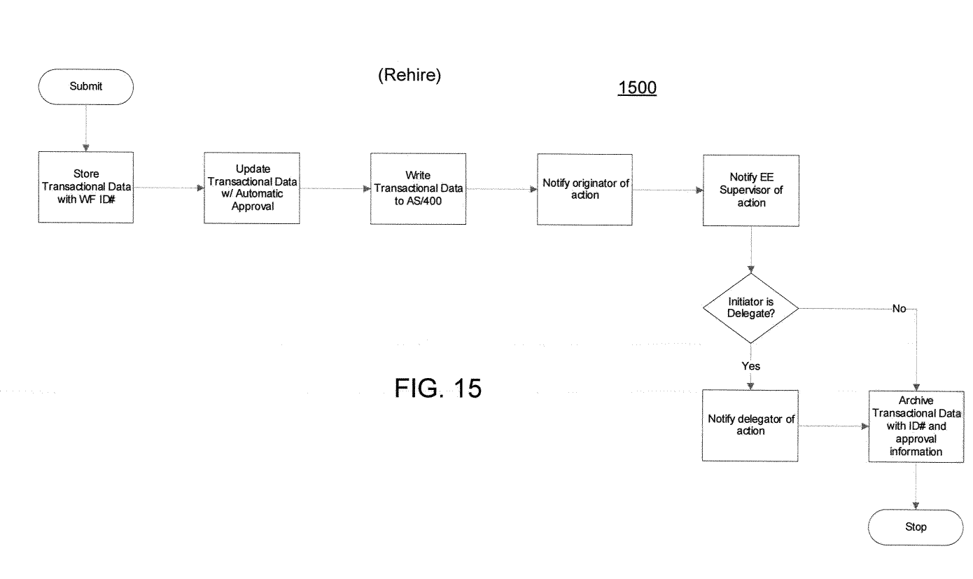

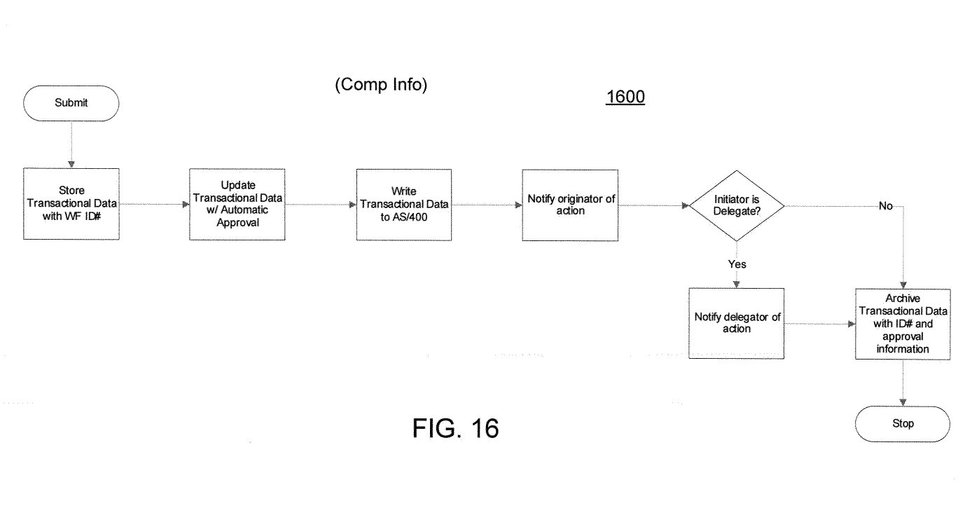

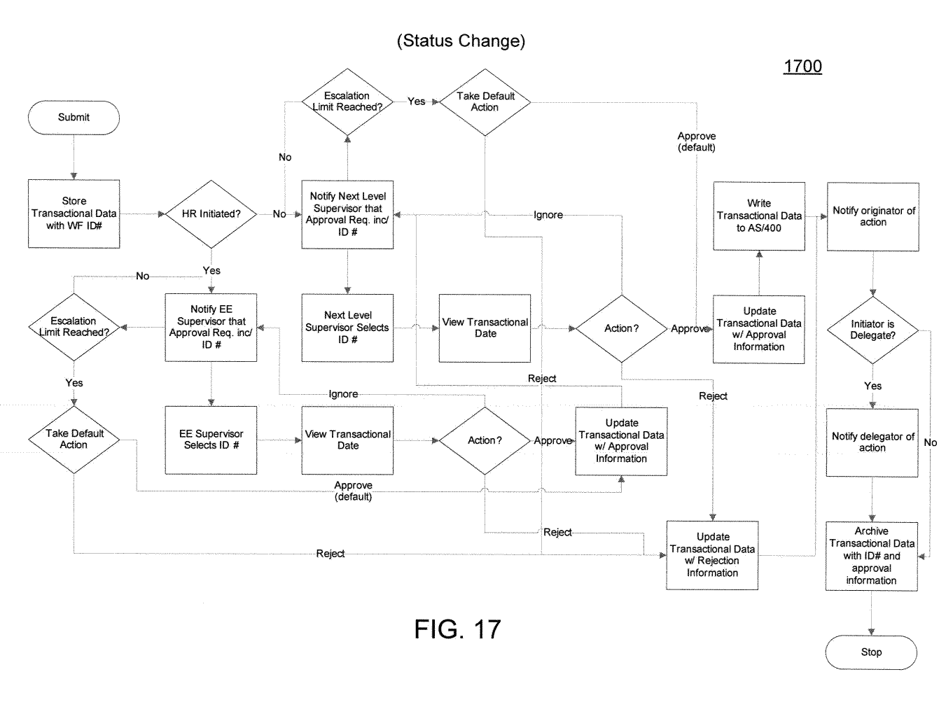

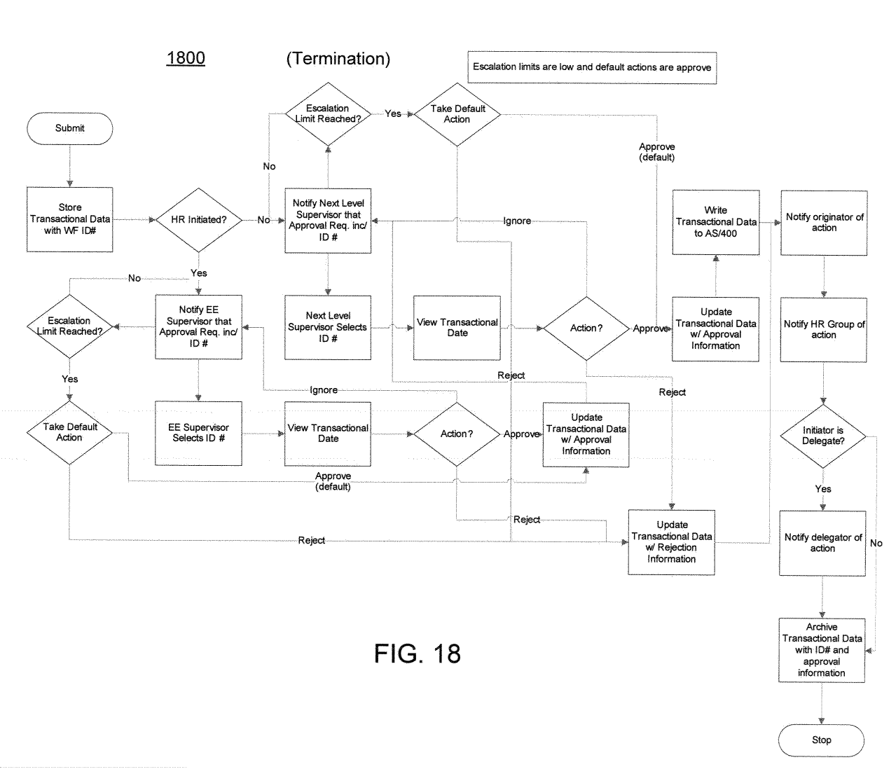

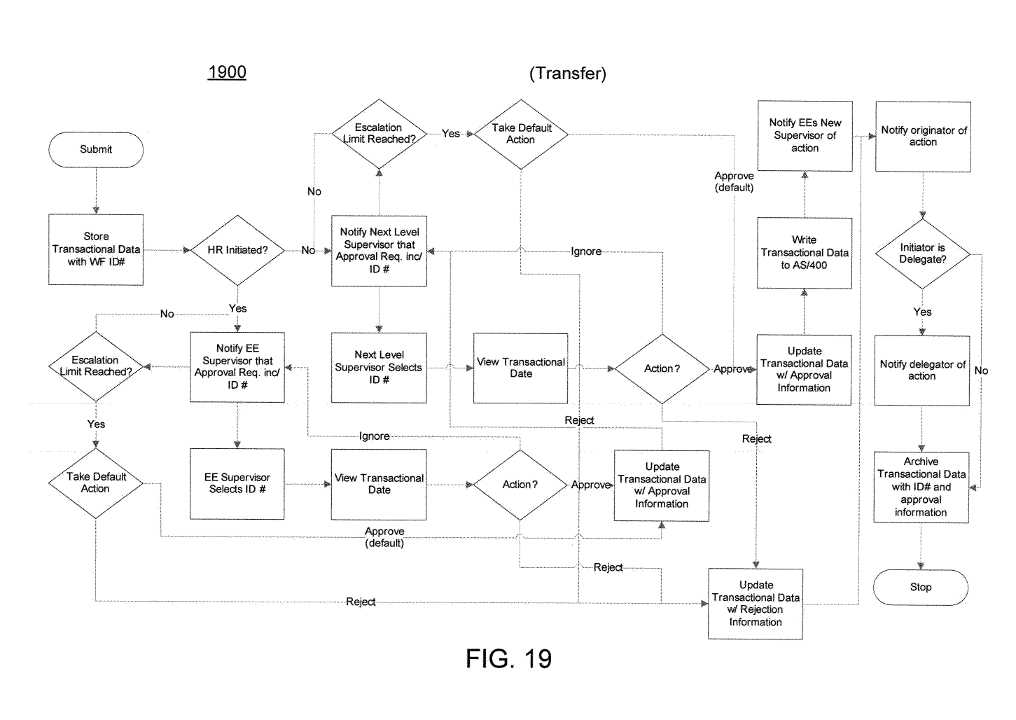

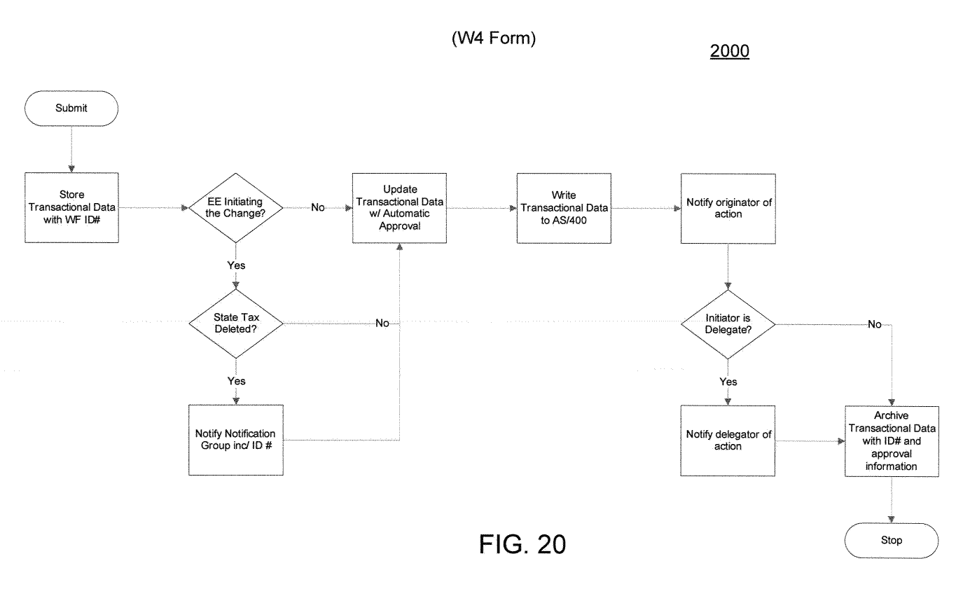

With an exemplary embodiment supporting human resources, transaction types include:
Salary Change (corresponding to workflow 400 as shown in FIG. 4): Transaction type changing an employee's salary. While the salary is typically increased, the salary may be decreased.
Contact Information (corresponding to workflow 500 as shown in FIG. 5): Transaction type for providing contact information for an employee. Any correspondence to the employee will be sent to the mailing address that is included in the contact information.
Demotion (corresponding to workflow 600 as shown in FIG. 6): Transaction type in which the employee is demoted (e.g., from a supervisor to a technical staff member).
Direct Deposit (corresponding to workflow 700 as shown in FIG. 7): Transaction type in which an employee's salary is directly deposited into a designated bank account.
Emergency Contact Information (corresponding to workflow 800 as shown in FIG. 8): Transaction type in which information is provided for contacting another person in case of an emergency situation, e.g., a spouse when the employee is injured.
Employment Information (corresponding to workflow 900 as shown in FIG. 9): Transaction type that provides a history of the employee's employment (e.g., start date of employment, current position, and previous positions).
Hire (corresponding to workflow 1000 as shown in FIG. 10): Transaction type documenting the hiring of the employee.
I9 Form (corresponding to workflow 1100 as shown in FIG. 11): Transaction type in which information is provided for the completion of Employment Eligibility Verification Form I-9. It is used by an employer to verify an employee's identity and to establish that the worker is eligible to accept employment in the United States.
Personal Information (corresponding to workflow 1200 as shown in FIG. 12): Transaction type in which personal information is provided. For example, the medical history of the employee may be included.
Promotion (corresponding to workflow 1300 as shown in FIG. 13): Transaction type in which the employee is promoted (e.g., from a supervisor to a department head).
Property (corresponding to workflow 1400 as shown in FIG. 14):
Rehire (corresponding to workflow 1500 as shown in FIG. 15): Transaction type in which a previous employee is rehired.
Compensation Information (corresponding to workflow 1600 as shown in FIG. 16): Transaction type in which an employee is provided compensation for a work activity. For example, an employee may be allowed to take additional vacation days or be given additional pay for working overtime.
Status Change (corresponding to workflow 1700 as shown in FIG. 17): Transaction type in which an employee changes status, e.g., marriage or citizenship.
Termination (corresponding to workflow 1800 as shown in FIG. 18): Transaction type in which an employee is terminated (i.e., the employee is fired or quits).
Transfer (corresponding to workflow 1900 as shown in FIG. 19): Transaction type in which an employee changes organizations within a company.
W4 Form (corresponding to workflow 2000 as shown in FIG. 20): Transaction type in which information is provided for the completion of Form W-4, which is a tax form used by the United States Internal Revenue Service.

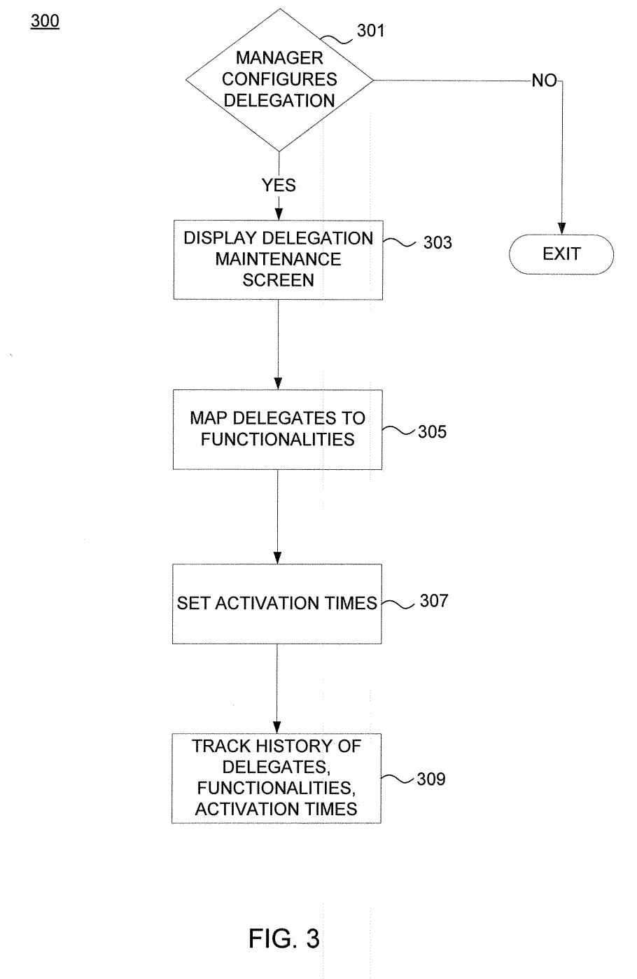

FIG. 3 shows flow diagram 300 for delegation configuration in accordance with an embodiment of the invention.

In step 301, a manager enters delegate configuration information to specify a delegate, transaction types that the delegate can initiate or approve, and a time period in which delegation is activated. Flexibility may be provided so that different delegates are associated with different transaction types. For example, a first delegate may be able to approve employee contact information but not the promotion or demotion of an employee that is under the supervision of the manager. However, a second delegate, e.g., another manager, may be able to approve transaction types that the first delegate is not able to approve.

The manager may also permit a delegate to initiate specified types of transactions. For example, the delegate may be able to initiate a transaction type but not be able to approve the transaction type. However, embodiments may provide the flexibility in which a delegate can approve and/or initiate a specified transaction type.

A manager may change delegates for a transaction type by specifying different delegates for different activation time periods. For example, a first delegate may be able to approve transaction requests during a first time period and a second delegate may be able to approve transaction requests during a second time period. Also, a plurality of delegates may be able to approve transaction requests during the same time period.

In step 303, as determined by step 301, a screenshot may be displayed to the manager if the manages desires to delegate authority for approving and/or initiating different actions (functions), e.g., changing salary information (corresponding to work flow 400 as shown in FIG. 4), demoting an employee (corresponding to work flow 600 as shown in FIG. 6), changing employee information (corresponding to work flow 900 as shown in FIG. 9), and hiring an employee (corresponding to work flow 1000 as shown in FIG. 10).

As will be discussed, the manager is able enter delegate configuration information in step 305 that maps one or more delegates to different functions. For example, the manager may designate a member of human resources (HR) to change salary information but only a different manager to demote an employee. Moreover, the manager may choose not to delegate selected functions so that the selected functions can be performed only by the manager. The manager can also activate delegate functionality based on start and end dates as entered in step 307. In step 309, process 300 tracks the history of delegates, delegated functions, and activation dates/times so that a record can be maintained for later confirmation.

With some embodiments, a delegation maintenance screen (not explicitly shown) is only available to those employees that are in human resources or have management roles. A manager may choose another manger to execute one or more tasks and may be able to select over the entire company in order to allow a manager to choose another manager to execute their tasks.

The maintenance screen may provide a selectable list of functionalities that the delegating manager has access so that the manager is able to select which of these functions the manager is delegating. With some embodiments, the maintenance screen may default to all items being checked. A manager may have unlimited delegates and the ability to determine which functions each delegate has the ability to execute on the manager's behalf. Also, the maintenance screen may provide the ability to have unlimited delegates assigned to the same function. For example, John delegates salary changes to both Jane and Fred.

With some embodiments, the maintenance screen may require a start and end date on each delegate and delegate function. The dates may be pro-actively chosen in advance. Error checking may also be performed. For example, the start and end dates cannot be prior to the date of entry, and the end date cannot be prior to the start date.

With some embodiments, maintenance screen may allow only one delegate to be set up, edited, or removed at a time. The maintenance screen may also provide a list of every delegate that is currently in effect. Also, system 100 may track the history of delegates, functions, and actual start/stop dates, and time that may not be available on the maintenance screen.

The maintenance screen may also provide the ability to edit all of the delegate functionality as discussed above. A user can choose a current delegate to edit by modifying functions the delegate has access to and by modifying start and end dates. With some embodiments, a delegate may have only one date range for all functionalities, and a delegator may have only one assignment set for a delegate. For example, a delegator cannot choose one delegate multiple times to allow for various date ranges for various functionalities. If a person is already a delegate and the person is selected again, the maintenance screen may display the delegate with current assigned functionality. System 100 may track changes to show the ending of a delegate's functionality.

Also, the maintenance screen may support the ability to delete a delegate in the active list. While the deleted entry remains in the system, system 100 sets the end date and end time immediately.

The maintenance screen may support functionalities for personnel actions. The maintenance screen may provide two check boxes per function, giving the delegate the ability to initiate and/or approve functions.

A delegate maintenance home screen view may include three boxes on the screen: 1) EE Search, 2) List of current and future delegates, and 3) an Edit box. With the EE Search box, when an employee is chosen, the employee will show up in the Edit Box to allow for assigning dates and functionality. The list of current and future delegates box provides the name of delegates and the corresponding start and end dates. The names may be sorted by name. The delegator may hover over a view icon to observe a view of the assigned functionality. When the delegator clicks on a name, the edit mode is entered. If so, the name is populated into the edit box.

The edit box displays the name of a delegate (view only), start and end dates, a select all button, a deselect all button, a cancel button, and a list of all functions that the delegator has access with already allowed functions checked.

FIG. 4 shows workflow 400 for salary change in accordance with an embodiment of the invention. When a supervisor (manager) has delegated this type of transaction to a designated delegate, approval is sent to the delegate rather than to the manager during the activation time period.

In steps 401 and 403, transactional data is submitted and stored and a workflow identification number (WG ID#) is associated with the transaction. For example, the manager of the employee, a delegate of the manager, or human resources may submit the transaction request for approval. If the transaction request is approved, the transaction is initiated.

If the transaction is submitted by human resources (as determined in step 405), the EE supervisor is notified that approval is required in step 407. The EE supervisor then selects the workflow identification number and views the transactional date in steps 439 and 441. The EE supervisor determines whether to approve, reject, or ignore the transaction in step 443. If the EE supervisor rejects the transaction, the transactional data with rejection information is updated in step 437 and the originator of the transaction (i.e., the person who submitted the transaction in step 401) is notified in step 427. If the initiator is the delegate, as determined by step 429, the delegator (i.e., the manager who delegated the responsibility) is notified in step 431. Transactional data is then archived in step 433. If the transaction is approved, then the transactional data is updated with the approval information in step 445.

If the transaction is not submitted by human resources (as determined by step 405), the next level supervisor is notified in step 415. If the escalation is reached as determined by step 413, the transaction request is either approved or rejected based on default action as determined by step 435. The next level supervisor views the transaction request in steps 417 and 419 and determines whether to approve, reject, or ignore the transaction request in step 421. If the next level supervisor rejects the transaction request, steps 437, 427, 429, 431, and 433 are executed as previously discussed. If the transaction request is approved, then transactional data is updated in steps 423 and 425 and steps 427, 429, 431, and 433. If the transaction request is ignored, then the next level is incremented and the next level supervisor is notified in step 415 until the escalation limit is reached in step 435.

The workflows as shown in FIGS. 5-20 may incorporate the same approach for approving transaction requests as discussed for workflow 400.

While a manager or delegate may explicitly approve a transaction request, embodiments support automatic approvals (auto-approvals), in which specified transaction types are automatically approved without the manager explicitly approving the transaction. Automatic approvals may be applicable only to selected transaction types (e.g., employee info) rather than to all transaction types (e.g., promotion and hiring).

FIG. 5 shows workflow 500 for contact information in accordance with an embodiment of the invention. In steps 501 and 503, a transaction is requested. If the territorial designation (e.g., state in the United States or province in Canada) changes, as determined by step 505, a notification group is notified in step 507. The transaction is then automatically approved in step 509. Steps 511, 513, 515, 517, and 519 are executed in a similar fashion as for the corresponding steps in FIG. 4.

FIG. 6 shows workflow 600 for demotion in accordance with an embodiment of the invention.

FIG. 7 shows workflow 700 for direct deposit in accordance with an embodiment of the invention.

FIG. 8 shows workflow 800 for emergency contact information in accordance with an embodiment of the invention.

FIG. 9 shows workflow 900 for employment information in accordance with an embodiment of the invention.

FIG. 10 shows workflow 1000 for hire in accordance with an embodiment of the invention.

FIG. 11 shows workflow 1100 for completing an I9 form in accordance with an embodiment of the invention.

FIG. 12 shows workflow 1200 for personal information in accordance with an embodiment of the invention.

FIG. 13 shows workflow 1300 for promotion in accordance with an embodiment of the invention.

FIG. 14 shows workflow 1400 for property in accordance with an embodiment of the invention.

FIG. 15 shows workflow 1500 for rehire in accordance with an embodiment of the invention.

FIG. 16 shows workflow 1600 for compensation information in accordance with an embodiment of the invention.

FIG. 17 shows workflow 1700 for status change in accordance with an embodiment of the invention.

FIG. 18 shows workflow 1800 for termination in accordance with an embodiment of the invention.

FIG. 19 shows workflow 1900 for transfer in accordance with an embodiment of the invention.

FIG. 20 shows workflow 20 00 for completing a W4 form in accordance with an embodiment of the invention.

As can be appreciated by one skilled in the art, a computer system with an associated computer-readable medium containing instructions for controlling the computer system may be utilized to implement the exemplary embodiments that are disclosed herein. The computer system may include at least one computer such as a microprocessor, a cluster of microprocessors, a mainframe, and networked workstations.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

I claim:

1. A computer-assisted method for supporting a web user interface, comprising:
receiving, by a computer from a manager through the web user interface, delegate configuration information, the delegate configuration information containing activation information and delegate function information for at least one delegate, wherein the activation information specifies a time period that the delegate configuration information is activated and the delegate function information specifies a transaction type that the at least one delegate can approve;
subsequently receiving, by the computer from an initiator through the web user interface, a request for a transaction;
when the request requires approval by the manager and the delegate configuration information is not activated, sending, by the computer, the request to the manager for approval before the transaction is initiated, wherein the transaction is associated with the transaction type; and
when the request requires approval by the manager and the delegate configuration information is activated, sending, by the computer, the request to one of the at least one delegate based on the delegate function information for approval before the transaction is initiated.

2. The method of claim 1, further comprising:
automatically escalating the request to a next level of approval when an escalation level has not been reached.

3. The method of claim 1, wherein the at least one delegate includes a first delegate and a second delegate and the delegate function information is indicative that the first delegate is associated with a first transaction type and the second delegate is associated with a second transaction type, the method further comprising:
when the request requires approval by the manager and the delegate configuration information is activated, sending the request to the first delegate for the first transaction type and to the second delegate for the second transaction type for approval before the transaction is initiated.

4. The method of claim 1, further comprising:
changing delegates for the transaction type based on the activation information and the delegate function information.

5. The method of claim 1, wherein a plurality of delegates are associated with the transaction type.

6. The method of claim 1, wherein the initiator is said one of the at least one delegate, further comprising:
notifying the manager of the request.

7. The method of claim 1, further comprising:
when the delegate configuration information is activated and the delegate function information is indicative that said one delegate is permitted to initiate the transaction type, initiating the transaction.

8. A computer-assisted method for supporting a web user interface, comprising:
receiving, by a computer from a manager through the web user interface, delegate configuration information, the delegate configuration information containing activation information and delegate function information for a delegate, wherein the activation information specifies a time period that the delegate configuration information is activated and the delegate function information specifies a transaction type that the delegate can initiate;
subsequently receiving, by the computer from the delegate a request for a transaction, wherein the transaction is associated with the transaction type; and
when the delegate configuration information is activated and the delegate function information is indicative that the delegate is permitted to initiate the transaction type, initiating the transaction.

9. The method of claim 8, further comprising:
when the request requires approval by the manager and the delegate configuration information is activated, sending, by the computer, the request to the delegate based on the delegate function information for approval before the transaction is initiated.

10. The method of claim 8, further comprising:
when a territorial designation in contact information changes, notifying a designated entity.

11. The method of claim 8, further comprising:
when state tax in an employee withholding allowance form is deleted, notifying a designated entity.

12. A computer-readable storage medium storing computer-executable instructions that, when executed, cause a processor to perform a method comprising:
receiving, by a computer from a manager through a web user interface, delegate configuration information, the delegate configuration information containing activation information and delegate function information for a first delegate, wherein the activation information specifies a time period that the delegate configuration information is activated and the delegate function information specifies a transaction type that the first delegate can manage;
subsequently receiving through the web user interface a request for a transaction;
when the request requires approval by the manager and the delegate configuration information is activated, sending the request to the first delegate based on the delegate function information for approval before the transaction is initiated, wherein the transaction is associated with the transaction type; and
when the delegate configuration information is activated and the delegate function information is indicative that the first delegate is permitted to initiate the transaction type, initiating the transaction.

13. The computer-readable medium of claim 12, said method further comprising:
automatically escalating the request to a next level of approval when an escalation limit has not been reached.

14. The computer-readable medium of claim 12, said method further comprising:
when the request requires approval by the manager and the delegate configuration information is activated, sending the request to the first delegate for a first transaction type and to a second delegate for a second transaction type for approval before the transaction is initiated, wherein the delegate function information is indicative that the first delegate is associated with the first transaction type and the second delegate is associated with the second transaction type.

15. The computer-readable medium of claim 12, said method further comprising:
changing delegates for the transaction type based on the activation information and the delegate function information.

16. The computer-readable medium of claim 12, said method further comprising:
notifying the manager of the request, wherein an initiator of the request is the first delegate.

17. The computer-readable medium of claim 12, said method further comprising:
when the delegate configuration information is activated and the delegate function information is indicative that the first delegate is permitted to initiate the transaction type, initiating the transaction.

18. An apparatus comprising:
a computer display;
a processor; and
a memory having stored therein machine executable instructions, that when executed cause the apparatus to:
receive, by a computer from a manager through a web user interface, delegate configuration information, the delegate configuration information containing activation information and delegate function information for a first delegate, wherein the activation information specifies a time period that the delegate configuration information is activated and the delegate function information specifies a transaction type that the first delegate can approve;
subsequently receive, by the computer through the web user interface, a request for a transaction; and
when the request requires approval by the manager and the delegate configuration information is activated, send the request to the first delegate based on the delegate function information for approval before the transaction is initiated, wherein the transaction is associated with the transaction type.

19. The apparatus of claim 18, wherein the instructions further cause the apparatus to:
automatically escalate the request to a next level of approval when an escalation limit has not been reached.

20. The apparatus of claim 18, wherein the instructions further cause the apparatus to:
when the request requires approval by the manager and the delegate configuration information is activated, send the request to the first delegate for a first transaction type and to a second delegate for a second transaction type for approval before the transaction is initiated, wherein the delegate function information is indicative that the first delegate is associated with the first transaction type and the second delegate is associated with the second transaction type.

21. The apparatus of claim 18, wherein the instructions further cause the apparatus to:
change delegates for the transaction type based on the activation information and the delegate function information.

22. The apparatus of claim 18, wherein the instructions further cause the apparatus to:
notify the manager of the request, wherein an initiator of the request is the first delegate.

23. The apparatus of claim 18, wherein the instructions further cause the apparatus to:
when the delegate configuration information is activated and the delegate function information is indicative that the first delegate is permitted to initiate the transaction type, initiate the transaction.

24. The method of claim 1, further comprising:
when the request does not require approval by the manager during the time period, automatically approving the request.
